(19) United States
(12) Patent Application Publication
(10) Pub. No.: US 2025/0373984 A1
(43) Pub. Date: Dec. 4, 2025

(54) PIEZOELECTRIC ACTUATOR WITH DAMPING

(71) Applicant: Cochlear Limited, Macquarie University, NSW (AU)

(72) Inventors: Armin Azhirnian, Gothenburg (SE); Henrik Fyrlund, Mölnlycke (SE); Dan Nyström, Mölndal (SE)

(21) Appl. No.: 18/869,801

(22) PCT Filed: Jul. 5, 2023
(86) PCT No.: PCT/IB2023/056971

§ 371 Date: Nov. 26, 2024

Related U.S. Application Data
(60) Provisional application No. 63/368,097, filed on Jul. 11, 2022.

(51) Int. Cl. H04R 7/26; H04R 17/10; H04R 25/00

(52) U.S. Cl. CPC H04R 7/26; H04R 17/10; H04R 25/606; H04R 2225/67; H04R 2440/01

(57) ABSTRACT

An apparatus includes at least one actuator configured to generate vibrations over a range of vibration frequencies. The at least one actuator includes a housing configured to be positioned on or within a recipient's body. The actuator further includes a support portion configured to be in operative communication with a fixture implanted within the recipient's body. The actuator further includes an oscillator within the housing, the oscillator includes piezoelectric material and has a first portion in mechanical communication with the support portion and a second portion spaced from the support portion. The piezoelectric material is configured to undergo bending oscillations in response to received electric voltage signals in which the second portion moves relative to the first portion. The actuator further includes at least one damper configured to damp at least one vibrational resonance of the at least one actuator over at least a portion of the range of vibration frequencies and independently of spring damping by the piezoelectric material.

### BACKGROUND

### Field

The present application relates generally to an implantable actuator for generating vibrations, and more specifically, to implantable auditory prostheses for generating auditory vibrations.

### Description of the Related Art

Medical devices have provided a wide range of therapeutic benefits to recipients over recent decades. Medical devices can include internal or implantable components/devices, external or wearable components/devices, or combinations thereof (e.g., a device having an external component communicating with an implantable component). Medical devices, such as traditional hearing aids, partially or fully-implantable hearing prostheses (e.g., bone conduction devices, mechanical stimulators, cochlear implants, etc.), pacemakers, defibrillators, functional electrical stimulation devices, and other medical devices, have been successful in performing lifesaving and/or lifestyle enhancement functions and/or recipient monitoring for a number of years.

The types of medical devices and the ranges of functions performed thereby have increased over the years. For example, many medical devices, sometimes referred to as “implantable medical devices,” now often include one or more instruments, apparatus, sensors, processors, controllers or other functional mechanical or electrical components that are permanently or temporarily implanted in a recipient. These functional devices are typically used to diagnose, prevent, monitor, treat, or manage a disease/injury or symptom thereof, or to investigate, replace or modify the anatomy or a physiological process. Many of these functional devices utilize power and/or data received from external devices that are part of, or operate in conjunction with, implantable components.

### SUMMARY

In one aspect disclosed herein, an apparatus comprises at least one actuator configured to generate vibrations over a range of vibration frequencies. The at least one actuator comprises a housing configured to be positioned on or within a recipient's body. The actuator further comprises a support portion configured to be in operative communication with a fixture implanted within the recipient's body. The actuator further comprises an oscillator within the housing. The oscillator comprises piezoelectric material and has a first portion in mechanical communication with the support portion and a second portion spaced from the support portion. The piezoelectric material is configured to undergo bending oscillations in response to received electric voltage signals in which the second portion moves relative to the first portion. The actuator further comprises at least one mass within the housing and in mechanical communication with the second portion. The at least one mass is configured to move with the second portion in response to the bending oscillations of the piezoelectric material. The actuator further comprises at least one damper configured to damp at least one vibrational resonance of the at least one actuator over at least a portion of the range of vibration frequencies and independently of spring damping by the piezoelectric material.

In another aspect disclosed herein, a method comprises applying oscillating electric voltage signals to a piezoelectric element mechanically coupled to a rigid portion and to at least one mass. The piezoelectric element responds to the electric voltage signals by imparting oscillatory motion to the at least one mass relative to the rigid portion. The method further comprises damping the oscillatory motion using viscoelastic damping, electromagnetic damping, and/or pneumatic damping.

In another aspect disclosed herein, an apparatus comprises a piezoelectric actuator configured to generate vibrational signals in response to oscillating electric voltage signals. The piezoelectric actuator is configured to be implanted on or within a recipient's body and to transmit the vibrational signals to the recipient's body. The piezoelectric actuator comprises at least one damper configured to use non-spring damping to damp at least one vibrational resonance of the piezoelectric actuator.

In another aspect disclosed herein, an apparatus comprises an actuator configured to be implanted on or within a recipient's body and to transmit the vibrational signals to the recipient's body. The actuator comprises at least one piezoelectric material and at least one surface layer overlaying a surface of the at least one piezoelectric material. The at least one piezoelectric material is configured to generate vibrational signals in response to oscillating electric voltage signals. The at least one surface layer extends into surface crevices, voids, and/or cracks of the at least one piezoelectric material.

### BRIEF DESCRIPTION OF THE DRAWINGS

Implementations are described herein in conjunction with the accompanying drawings, in which:

FIG. 1A schematically illustrates a portion of an example transcutaneous bone conduction device implanted in a recipient in accordance with certain implementations described herein;

FIG. 1B schematically illustrate a portion of another example transcutaneous bone conduction device implanted in a recipient in accordance with certain implementations described herein;

FIG. 1C depicts a side view of a portion of an example percutaneous bone conduction device in accordance with certain implementations described herein;

FIG. 2 schematically illustrates a cross-sectional view of an example apparatus having at least one mechanical damper positioned between the oscillator and the at least one mass in accordance with certain implementations described herein;

FIGS. 3A-3D schematically illustrate cross-sectional views of an example apparatus having at least one mechanical damper between the support portion and the at least one mass in accordance with certain implementations described herein;

FIG. 3E schematically illustrates a cross sectional view of an example apparatus having at least one mechanical damper between the housing and the at least one mass in accordance with certain implementations described herein;

FIGS. 4A-4C schematically illustrate cross-sectional views of three example apparatus in which the at least one electromagnetic damper comprises at least one permanent magnet in accordance with certain implementations described herein;

FIGS. 5A-5C schematically illustrate cross-sectional views of three example apparatus comprising at least one pneumatic damper in accordance with certain implementations described herein;

FIG. 6A schematically illustrates an example damping of a vibrational resonance in accordance with certain implementations described herein;

FIG. 6B schematically illustrates an example damping of a vibrational antiresonance in accordance with certain implementations described herein; and

FIG. 7 is a flow diagram of an example method in accordance with certain implementations described herein.

### DETAILED DESCRIPTION

Certain implementations described herein provide a piezoelectric actuator having at least one damping element configured to damp at least one vibrational resonance over at least a portion of the range of vibration frequencies of the piezoelectric actuator independently of spring damping by the piezoelectric material (e.g., damping properties of the damping element can be tuned independently from the vibrational properties of the actuator). Examples of damping elements include but are not limited to mechanical dampers comprising at least one viscoelastic material configured to experience a shearing force, electromagnetic dampers comprising at least one permanent magnet configured to generate eddy currents, and/or pneumatic dampers comprising a gas or liquid configured to compress/expand and/or to flow through at least one orifice. The at least one damping element can facilitate mechanical coupling with the piezoelectric material to provide a more even and/or more reliable force transfer from the piezoelectric material.

The teachings detailed herein are applicable, in at least some implementations, to any type of implantable medical device (e.g., implantable vibration stimulation system or device; bone conduction auditory prosthesis) comprising a first portion implanted on or within the recipient's body and configured to provide vibrations to a portion of the recipient's body. Implementations can include any type of medical device that can utilize the teachings detailed herein and/or variations thereof. Furthermore, while certain implementations are described herein in the context of implantable auditory prosthesis devices, certain other implementations are compatible in the context of other implantable or non-implantable devices or systems (e.g., bone conduction headphones; bone conduction speakers; bone conduction microphones; ultrasonic imaging).

Merely for ease of description, apparatus and methods disclosed herein are primarily described with reference to an illustrative medical device, namely an active transcutaneous or percutaneous bone conduction auditory prosthesis systems. However, the teachings detailed herein and/or variations thereof may also be used with a variety of other medical or non-medical systems that provide a wide range of therapeutic benefits to recipients, patients, or other users. In some implementations, the teachings detailed herein and/or variations thereof can be utilized in other types of devices beyond auditory prostheses that may benefit from a vibration-generating actuator able to fit within a region having restricted space and/or improved control of piezoelectric vibrations (e.g., a direction of vibration motion). Implementations can include any type of auditory prosthesis that can utilize the teachings detailed herein and/or variations thereof. Certain such implementations can be referred to as “partially implantable,” “semi-implantable,” “mostly implantable,” “fully implantable,” or “totally implantable” auditory prostheses. In some implementations, the teachings detailed herein and/or variations thereof can be utilized in other types of prostheses beyond auditory prostheses.

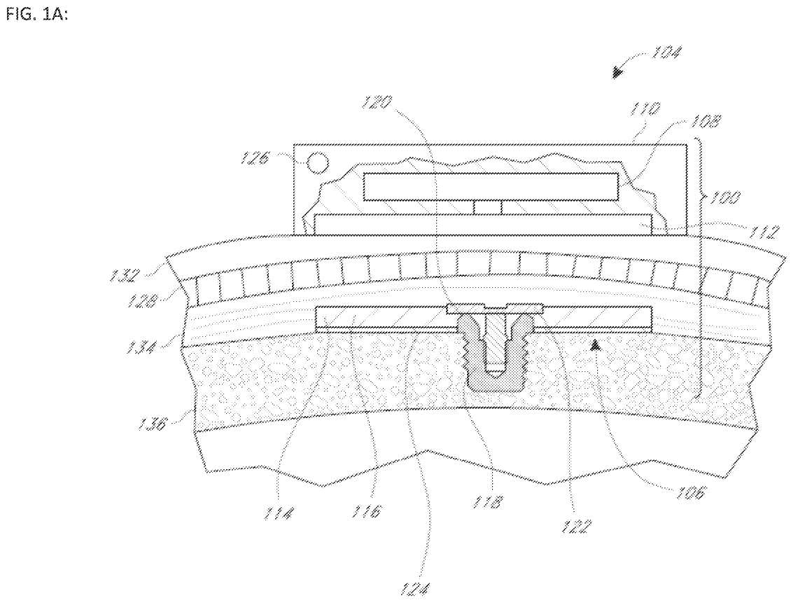

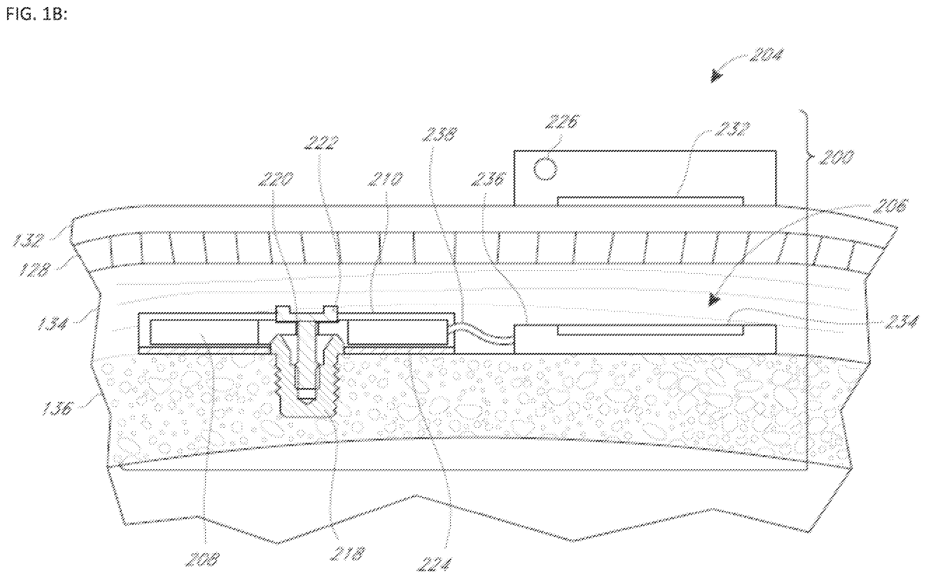

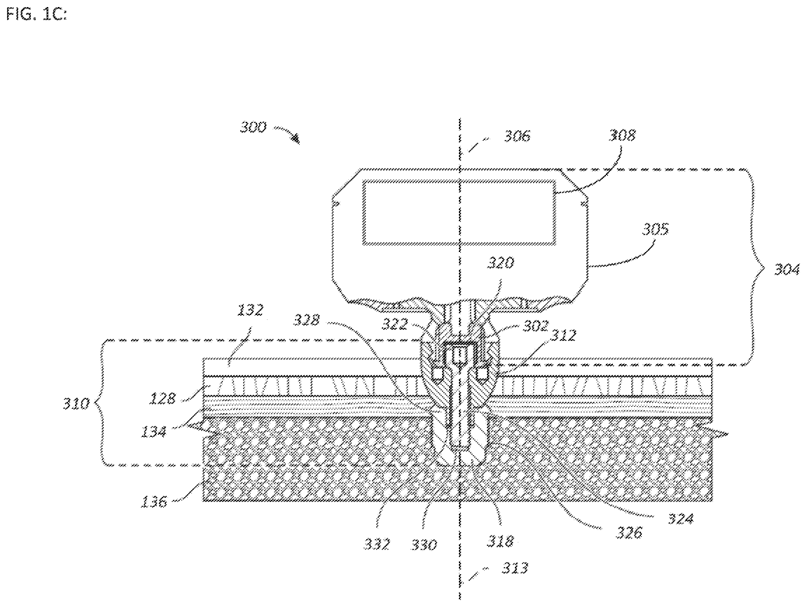

FIG. 1A schematically illustrates a portion of an example transcutaneous bone conduction device 100 implanted in a recipient in accordance with certain implementations described herein. FIG. 1B schematically illustrate a portion of another example transcutaneous bone conduction device 200 implanted in a recipient in accordance with certain implementations described herein. FIG. 1C schematically illustrates a side view of a portion of an example percutaneous bone conduction device 300 in accordance with certain implementations described herein.

The example transcutaneous bone conduction device 100 of FIG. 1A includes an external device 104 and an implantable component 106. The transcutaneous bone conduction device 100 of FIG. 1A is a passive transcutaneous bone conduction device in that a vibrating actuator 108 is located in the external device 104 and delivers vibrational stimuli through the skin 132 to the skull 136. The vibrating actuator 108 is located in a housing 110 of the external component 104 and is coupled to a plate 112. The plate 112 can be in the form of a permanent magnet and/or in another form that generates and/or is reactive to a magnetic field, or otherwise permits the establishment of magnetic attraction between the external device 104 and the implantable component 106 sufficient to hold the external device 104 against the skin 132 of the recipient.

In certain implementations, the vibrating actuator 108 is a device that converts electrical signals into vibration. In operation, a sound input element 126 can convert sound into electrical signals. Specifically, the transcutaneous bone conduction device 100 can provide these electrical signals to the vibrating actuator 108, or to a sound processor (not shown) that processes the electrical signals, and then provides those processed signals to the vibrating actuator 108. The vibrating actuator 108 can convert the electrical signals (processed or unprocessed) into vibrations. Because the vibrating actuator 108 is mechanically coupled to the plate 112, the vibrations are transferred from the vibrating actuator 108 to the plate 112. The implanted plate assembly 114 is part of the implantable component 106, and is made of a ferromagnetic material that may be in the form of a permanent magnet, that generates and/or is reactive to a magnetic field, or otherwise permits the establishment of a magnetic attraction between the external device 104 and the implantable component 106 sufficient to hold the external device 104 against the skin 132 of the recipient. Accordingly, vibrations produced by the vibrating actuator 108 of the external device 104 are transferred from the plate 112 across the skin 132 to a plate 116 of the plate assembly 114. This can be accomplished as a result of mechanical conduction of the vibrations through the skin 132, resulting from the external device 104 being in direct contact with the skin 132 and/or from the magnetic field between the two plates 112, 116. These vibrations are transferred without a component penetrating the skin 132, fat 128, or muscular 134 layers on the head.

In certain implementations, the implanted plate assembly 114 is substantially rigidly attached to a bone fixture 118. The implantable plate assembly 114 can include a through hole 120 that is contoured to the outer contours of the bone fixture 118. This through hole 120 thus forms a bone fixture interface section that is contoured to the exposed section of the bone fixture 118. In certain implementations, the sections are sized and dimensioned such that at least a slip fit or an interference fit exists with respect to the sections. A screw 122 can be used to secure the plate assembly 114 to the bone fixture 118. In certain implementations, a silicone layer 124 is located between the plate 116 and the bone 136 of the skull.

As can be seen in FIG. 1A, the head of the screw 122 is larger than the hole through the implantable plate assembly 114, and thus the screw 122 positively retains the implantable plate assembly 114 to the bone fixture 118. The portions of the screw 122 that interface with the bone fixture 118 substantially correspond to an abutment screw, thus permitting the screw 122 to readily fit into an existing bone fixture used in a percutaneous bone conduction device. In certain implementations, the screw 122 is configured so that the same tools and procedures that are used to install and/or remove an abutment screw from the bone fixture 118 can be used to install and/or remove the screw 122 from the bone fixture 118.

As schematically illustrated by FIG. 1B, an example transcutaneous bone conduction device 200 comprises an external device 204 and an implantable component 206. The device 200 is an active transcutaneous bone conduction device in that the vibrating actuator 208 is located in the implantable component 206. For example, a vibratory element in the form of a vibrating actuator 208 is located in a housing 210 of the implantable component 206. In certain implementations, much like the vibrating actuator 108 described herein with respect to the transcutaneous bone conduction device 100, the vibrating actuator 208 is a device that converts electrical signals into vibration. The vibrating actuator 208 can be in direct contact with the outer surface of the recipient's skull 136 (e.g., the vibrating actuator 208 is in substantial contact with the recipient's bone 136 such that vibration forces from the vibrating actuator 208 are communicated from the vibrating actuator 208 to the recipient's bone 136). In certain implementations, there can be one or more thin non-bone tissue layers (e.g., a silicone layer 224) between the vibrating actuator 208 and the recipient's bone 136 (e.g., bone tissue) while still permitting sufficient support so as to allow efficient communication of the vibration forces generated by the vibrating actuator 208 to the recipient's bone 136.

In certain implementations, the external component 204 includes a sound input element 226 that converts sound into electrical signals. Specifically, the device 200 provides these electrical signals to the vibrating actuator 208, or to a sound processor (not shown) that processes the electrical signals, and then provides those processed signals to the implantable component 206 through the skin of the recipient via a magnetic inductance link. For example, a communication coil 232 of the external component 204 can transmit these signals to an implanted communication coil 234 located in a housing 236 of the implantable component 206. Components (not shown) in the housing 236, such as, for example, a signal generator or an implanted sound processor, then generate electrical signals to be delivered to the vibrating actuator 208 via electrical lead assembly 238. The vibrating actuator 208 converts the electrical signals into vibrations. In certain implementations, the vibrating actuator 208 can be positioned with such proximity to the housing 236 that the electrical leads 238 are not present (e.g., the housing 210 and the housing 236 are the same single housing containing the vibrating actuator 208, the communication coil 234, and other components, such as, for example, a signal generator or a sound processor).

In certain implementations, the vibrating actuator 208 is mechanically coupled to the housing 210. The housing 210 and the vibrating actuator 208 collectively form a vibrating element. The housing 210 can be substantially rigidly attached to a bone fixture 218. In this regard, the housing 210 can include a through hole 220 that is contoured to the outer contours of the bone fixture 218. The screw 222 can be used to secure the housing 210 to the bone fixture 218. As can be seen in FIG. 1B, the head of the screw 222 is larger than the through hole 220 of the housing 210, and thus the screw 222 positively retains the housing 210 to the bone fixture 218. The portions of the screw 222 that interface with the bone fixture 218 substantially correspond to the abutment screw detailed below, thus permitting the screw 222 to readily fit into an existing bone fixture used in a percutaneous bone conduction device (or an existing passive bone conduction device). In certain implementations, the screw 222 is configured so that the same tools and procedures that are used to install and/or remove an abutment screw from the bone fixture 218 can be used to install and/or remove the screw 222 from the bone fixture 218.

The example transcutaneous bone conduction auditory device 100 of FIG. 1A comprises an external sound input element 126 (e.g., external microphone) and the example transcutaneous bone conduction auditory device 200 of FIG. 1B comprises an external sound input element 226 (e.g., external microphone). Other example auditory devices (e.g., totally implantable transcutaneous bone conduction devices) in accordance with certain implementations described herein can replace the external sound input element 126, 226 with a subcutaneously implantable sound input assembly (e.g., implanted microphone).

In certain implementations, the example percutaneous bone conduction device 300 comprises an operationally removable component 304 and a bone conduction implant 310, as schematically illustrated by FIG. 1C. The operationally removable component 304 comprises a housing 305 and is operationally releasably coupled to the bone conduction implant 310. By operationally releasably coupled, it is meant that it is releasable in such a manner that the recipient can relatively easily attach and remove the operationally removable component 304 during normal use of the percutaneous bone conduction device 300, repeatedly if desired. Such releasable coupling is accomplished via a coupling apparatus 302 of the operationally removable component 304 and a corresponding mating apparatus (e.g., abutment 312) of the bone conduction implant 310, as will be detailed below. This operationally releasable coupling is contrasted with how the bone conduction implant 310 is attached to the skull, as will also be detailed below.

The operationally removable component 304 of certain implementations includes a sound input element (e.g., a microphone; a cable or wireless connection configured to receive signals indicative of sound from an audiovisual device), a sound processor (e.g., sound processing circuitry, control electronics, actuator drive components, power module) configured to generate control signals in response to electrical signals from the sound input element, and at least one vibrating actuator 308 configured to generate acoustic vibrations in response to the control signals. The at least one vibrating actuator 308 can comprise a vibrating electromagnetic actuator, a vibrating piezoelectric actuator, and/or another type of vibrating actuator, and the operationally removable component 304 is sometimes referred to herein as a vibrator unit. The control signals are configured to cause the at least one vibrating actuator 308 to vibrate, generating a mechanical output force in the form of acoustic vibrations that is delivered to the skull of the recipient via the bone conduction implant 310. In other words, the operationally removable component 304 converts received sound signals into mechanical motion using the at least one vibrating actuator 308 to impart vibrations to the recipient's skull which are detected by the recipient's ossicles and/or cochlea. In certain implementations, the operationally removable component 304 comprises a single housing 305, as schematically illustrated by FIG. 1C, while in certain other implementations, the operationally removable component 304 comprises a plurality of housings (e.g., separate or different housings, which can have wired and/or wireless connections therebetween).

As schematically illustrated in FIG. 1C, the operationally removable component 304 further includes a coupling apparatus 302 configured to operationally removably attach the operationally removable component 304 to a bone conduction implant 310 (also referred to as an anchor system and/or a fixation system) which is implanted in the recipient. The coupling apparatus 302 can be configured to be repeatedly coupled to and decoupled from the bone conduction implant 310. The coupling apparatus 302 comprises a longitudinal axis 306 (e.g., an axis along a length of the coupling apparatus 302; an axis about which the coupling apparatus 302 is at least partially symmetric). The at least one vibrating actuator 308 of the operationally removable component 304 is in vibrational communication with the coupling apparatus 302 such that vibrations generated by the at least one vibrating actuator 308 are transmitted to the coupling apparatus 302 and then to the bone conduction implant 310 in a manner that at least effectively evokes a hearing percept.

The example bone conduction implant 310 of FIG. 1C comprises a percutaneous abutment 312, a bone fixture 318 (hereinafter sometimes referred to as the fixture 318), and an abutment screw 320. While FIG. 1C illustrates one example bone conduction implant 310 in accordance with certain implementations described herein, other bone conduction implants 310 (e.g., comprising abutments 312, fixtures 318, and/or abutment screws 320 of any type, size/having any geometry) are also compatible with certain implementations described herein.

In certain implementations, the coupling apparatus 302 is configured to be removably attached to the bone conduction implant 310 by pressing the coupling apparatus 302 against the abutment 312 in a direction along (e.g., substantially parallel to) the longitudinal axis 306 of the coupling apparatus 302 and/or along (e.g., substantially parallel to) the longitudinal axis 313 of the abutment 312. In certain such implementations, the coupling apparatus 302 can be configured to be snap-coupled to the abutment 312. In certain implementations, as depicted by FIG. 1C, the coupling apparatus 302 comprises a male component and the abutment 312 comprises a female component configured to mate with the male component of the coupling apparatus 302. In certain implementations, this configuration can be reversed, with the coupling apparatus 302 comprises a female component and the abutment 312 comprises a male component configured to mate with the female component of the coupling apparatus 302.

The abutment 312 of certain implementations is symmetrical with respect to at least those portions of the abutment 312 above the top portion of the fixture 318. For example, the exterior surfaces of the abutment 312 can form concentric outer profiles about a longitudinal axis 313 of the abutment 312 (e.g., an axis along a length of the abutment 312; an axis about which the abutment 312 is at least partially symmetric). As shown in FIG. 1C, the exterior surfaces of the abutment 312 establish diameters lying on planes normal to the longitudinal axis 313 that vary along the length of the longitudinal axis 313. For example, the abutment 312 can include outer diameters that progressively become larger with increased distance from the fixture 318. In certain other implementations, the outer diameters can have other outer profiles.

In certain implementations, the abutment 312 is configured for integration between the skin and the abutment 312. Integration between the skin and the abutment 312 can be considered to occur when the soft tissue of the skin 132 encapsulates the abutment 312 in fibrous tissue and does not readily dissociate itself from the abutment 312, which can inhibit the entrapment and/or growth of microbes proximate the bone conduction implant 310. For example, the abutment 312 can have a surface having features which are configured to reduce certain adverse skin reactions. In certain implementations, the abutment 312 is coated to reduce the shear modulus, which can also encourage skin integration with the abutment 213. For example, at least a portion of the abutment 312 can be coated with or otherwise contain a layer of hydroxyapatite that enhances the integration of skin with the abutment 312.

In certain implementations, the abutment 312 is configured to be attached to the fixture 318 via the abutment screw 320, and the fixture 318 is configured to be fixed to (e.g., screwed into) the recipient's skull bone 136. The abutment 312 extends from the fixture 318, through muscle 134, fat 128, and skin 132 so that the coupling apparatus 140 can be attached thereto. The abutment screw 320 (e.g., comprising a screw head 322 and an elongate coupling shaft 324 connected to the screw head 322) connects and holds the abutment 312 to the fixture 318, thereby rigidly attaching the abutment 312 to the fixture 318. The rigid attachment is such that the abutment 312 is vibrationally connected to the fixture 318 such that at least some of the vibrational energy transmitted to the abutment 312 is transmitted to the fixture 318 in a sufficient manner to effectively evoke a hearing percept (e.g., to mechanically vibrate the skull bone of the recipient, the vibrations received by the recipient's cochlea to compensate for conductive hearing loss, mixed hearing loss, or single-sided deafness). The percutaneous abutment 312 provides an attachment location for the coupling apparatus 302 that facilitates efficient transmission of mechanical force.

The fixture 318 can be made of any material that has a known ability to integrate into surrounding bone tissue (e.g., comprising a material that exhibits acceptable osseointegration characteristics). In certain implementations, the fixture 318 is formed from a single piece of material (e.g., titanium) and comprises outer screw threads 326 forming a male screw which is configured to be installed into the skull bone 136 and a flange 328 configured to function as a stop when the fixture 318 is implanted into the skull bone 136. The screw threads 326 can have a maximum diameter of about 3.5 mm to about 5.0 mm, and the flange 328 can have a diameter which exceeds the maximum diameter of the screw threads 326 (e.g., by approximately 10%-20%). The flange 328 can have a planar bottom surface for resting against the outer bone surface, when the fixture 318 has been screwed down into the skull bone 136. The flange 328 prevents the fixture 318 (e.g., the screw threads 326) from potentially completely penetrating completely through the bone 136.

The body of the fixture 318 can have a length sufficient to securely anchor the fixture 318 to the skull bone 136 without penetrating entirely through the skull bone 136. The length of the body can therefore depend on the thickness of the skull bone 136 at the implantation site. For example, the fixture 318 can have a length, measured from the planar bottom surface of the flange 328 to the end of the distal region (e.g., the portion farthest from the flange 328), that is no greater than 5 mm or between about 3.0 mm to about 5.0 mm, which limits and/or prevents the possibility that the fixture 318 might go completely through the skull bond 136.

The interior of the fixture 318 can further include an inner lower bore 330 having female screw threads configured to mate with male screw threads of the elongate coupling shaft 324 to secure the abutment screw 320 and the abutment 312 to the fixture 318. The fixture 318 can further include an inner upper bore 332 that receives a bottom portion of the abutment 312. While FIG. 1C shows the coupling apparatus 302 directly engaging with (e.g., directly contacting) the abutment screw 320 (e.g., the screw head 322), in certain other implementations, the coupling apparatus 302 engages with the abutment 312 without directly engaging with (e.g., without directly contacting) the abutment screw 320.

In certain implementations, the bottom of the abutment 312 includes a fixture connection section extending below a reference plane extending across the top of the fixture 318 and that interfaces with the fixture 318. Upon sufficient tensioning of the abutment screw 320, the abutment 312 sufficiently elastically and/or plastically stresses the fixture 318, and/or visa-versa, so as to form a tight seal at the interface of surfaces of the abutment 312 and the fixture 318. Certain such implementations can reduce (e.g., eliminate) the chances of micro-leakage of microbes into the gaps between the abutment 312, the fixture 318 and the abutment screw 320.

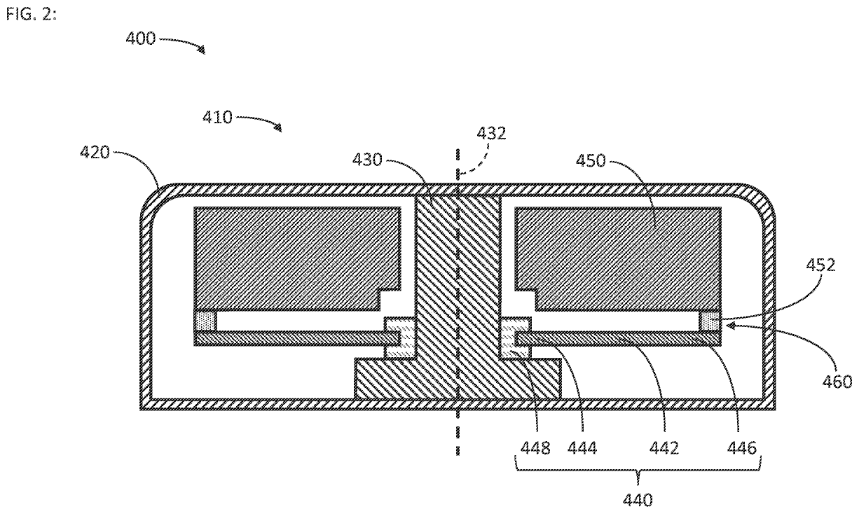

FIGS. 2, 3A-3E, 4A-4C, 5A-5C, and 6 schematically illustrate side cross-sectional views of various example apparatus 400 in accordance with certain implementations described herein. The example apparatus 400 of FIGS. 2, 3A-3E, 4A-4C, 5A-5C, and 6 can be an external component 104 of a passive transcutaneous bone conduction device 100 as schematically illustrated by FIG. 1A, an implantable component 206 of an active transcutaneous bone conduction device 200 as schematically illustrated in FIG. 1B, or an operationally removable component 304 of a percutaneous bone conduction device 300 as schematically illustrated in FIG. 1C.

The example apparatus 400 as schematically illustrated by FIGS. 2, 3A-3E, 4A-4C, 5A-5C, and 6 comprises at least one actuator 410 configured to generate vibrations over a range of vibration frequencies. The at least one actuator 410 comprises a housing 420 configured to be positioned on or within a recipient's body. The at least one actuator 410 further comprises a support portion 430 configured to be in operative communication with a fixture (e.g., bone fixture 118, 218, 318) implanted within the recipient's body. The at least one actuator 410 further comprises an oscillator 440 within the housing 420. The oscillator 440 comprises piezoelectric material 442 and has a first portion 444 in mechanical communication with the support portion 430 and a second portion 446 spaced from the support portion 430. The piezoelectric material 442 is configured to undergo bending oscillations in response to received electric voltage signals in which the second portion 446 moves relative to the first portion 444. The at least one actuator 410 further comprises at least one mass 450 within the housing 410 and in mechanical communication with the second portion 446. The at least one mass 450 is configured to move with the second portion 446 in response to the bending oscillations of the piezoelectric material 442. The at least one actuator 410 further comprises at least one damper 460 configured to damp vibrational resonances of the at least one actuator 410 over at least a portion of the range of vibration frequencies and independently of spring damping by the piezoelectric material 442.

In certain implementations, the at least one actuator 410 comprises a vibrating actuator 108 within the housing 420 (e.g., housing 110) external to the recipient's body (e.g., on the recipient's skin 132), and the support portion 430 comprises at least one elongate structure (e.g., cylindrical element; post; screw) and a plate 112 (e.g., permanent magnet and/or other ferromagnetic or ferrimagnetic element) that is affixed to the elongate structure and is magnetically attracted to a corresponding implanted plate assembly 114 substantially rigidly attached to a bone fixture 118 (e.g., the plate 112, plate assembly 114, and magnetic attraction force operatively coupling the support portion 430 to the fixture). In certain other implementations, the at least one actuator 410 comprises a vibrating actuator 208 within the housing 420 (e.g., housing 210) implanted within the recipient's body (e.g., beneath tissue of the recipient; beneath skin 132, fat 128, and/or muscular 134 layers; on a bone 136), and the support portion 430 comprises at least one elongate structure 220 (e.g., cylindrical element; post; screw 222) rigidly affixed to a bone fixture 218 (e.g., via a clamp, screw, adhesive, epoxy, or other coupler). In certain other implementations, the at least one actuator 410 comprises a vibrating actuator 308 within the housing 420 (e.g., external housing 305) having a coupling apparatus 302 that is configured to mate with an abutment 312 of the bone conduction implant 310, and the support portion 420 comprises at least one elongate structure (e.g., cylindrical element; post; screw) in mechanical communication with the bone fixture 318 via the coupling apparatus 302 and the abutment 312.

In certain implementations, the actuator 410 is configured to generate vibrational energy (e.g., vibrations) within a range of vibrational frequencies that are perceptible by the recipient as sound (e.g., a range of 20 Hz to 20 kHz), which are referred to herein as auditory vibrations. The support portion 430 is part of a propagation path for the auditory vibrations to be transmitted to the fixture (e.g., bone fixture 118, 218, 318) and to propagate via bone conduction from the fixture to an inner ear region (e.g., within the temporal bone and comprising the vestibule, the cochlea, and the semicircular canals) and/or a middle ear region (e.g., within the recipient's head, partially bounded by the tympanic membrane and comprising the ossicles, the round window, the oval window, and the Eustachian tube) to be detected as sound.

In certain implementations, the housing 420 (e.g., housing 110, 210, 305) is configured to hermetically seal the oscillator 440 and the at least one mass 450 from an environment surrounding the actuator 410. The housing 420 can have a length and/or a width less than or equal to 40 millimeters (e.g., in a range of 15 millimeters to 35 millimeters; in a range of 25 millimeters to 35 millimeters; in a range of less than 30 millimeters; in a range of 15 millimeters to 30 millimeters), and/or a thickness less than or equal to 7 millimeters (e.g., in a range of less than or equal to 6 millimeters, in a range of less than or equal to 5 millimeters; in a range of less than or equal to 4 millimeters). The housing 420 of certain implementations comprises at least one biocompatible material (e.g., plastic; PEEK; silicone; ceramic; zirconium oxide).

In certain implementations, the support portion 430 is configured to be rigidly affixed to the oscillator 440, to support the oscillator 440 within the housing 420, and to transmit vibrations from the oscillator 440 to the fixture (e.g., bone fixture 118, 218, 318) implanted within the recipient's body. The support portion 430 of certain implementations comprises a substantially rigid material (e.g., metal) and can be substantially cylindrically symmetric about a longitudinal axis 432 of the support portion 430.

In certain implementations, the piezoelectric material 442 of the oscillator 440 comprises a unitary (e.g., single; monolithic) component. The oscillator 440 of certain implementations comprises two or more layers in mechanical communication with one another (e.g., bonded together) into a unitary component (e.g., a stack), at least one of the layers comprising the piezoelectric material 442 (e.g., unimorph having one piezoelectric layer and a non-piezoelectric layer; bimorph having two or more piezoelectric layers). The unitary component can comprise other non-piezoelectric materials, such as a bonding material (e.g., adhesive; epoxy; metal) between piezoelectric layers, electrically conductive material (e.g., metal) configured to apply electrical voltage signals to the piezoelectric material 442, and/or a non-piezoelectric layer (e.g., metal backplate) affixed to the piezoelectric material 442. In certain implementations, the number of layers of the oscillator 440 are selected to provide a predetermined power, size (e.g., area, thickness), stiffness, and/or resonance frequency. Examples of piezoelectric materials compatible with certain implementations described herein include but are not limited to: quartz; gallium orthophosphate; langasite; barium titanate; lead titanate; lead zirconate titanate (PZT); potassium niobate; lithium niobate; lithium tantalate; sodium tungstate; sodium potassium niobate; bismuth ferrite; sodium niobate; polyvinylidene fluoride; macro fiber composite (MFC); other piezoelectric crystals, ceramics, or polymers.

In certain implementations, the oscillator 440 is substantially planar (e.g., plate; sheet; slab; disc-shaped). For example, the piezoelectric material 442 can comprise a generally rectangular plate, a generally circular disk, or another planar shape (e.g., oval; polygonal with 5, 6, 7, 8, or more sides; geometric; non-geometric; regular; irregular). In certain implementations, the oscillator 440 has a length (e.g., in a range of 2 millimeters to 20 millimeters), a width substantially perpendicular to the length (e.g., in a range of 2 millimeters to 20 millimeters), and a thickness substantially perpendicular to the length and to the width (e.g., in a range of less than 2 millimeters; less than 1 millimeter; greater than 300 microns). Various configurations and geometries of the oscillator 440 are compatible with certain implementations described herein (see, e.g., “Piezoelectric Ceramic Products: Fundamentals, Characteristics and Applications,” Physik Instruments (PI) GmbH & Co., Lederhose, Germany, www.piceramic.com, (2016)).

In certain implementations, the first portion 444 of the oscillator 440 is rigidly affixed to the support portion 430 by a coupler 448 (e.g., clamp, screw, adhesive, epoxy) and does not substantially move relative to the support portion 430 during the bending oscillations of the oscillator 440. For example, the first portion 444 can comprise a hole (e.g., the hole has an inner perimeter that is part of the first portion 444) with the support portion 430 extending along a longitudinal axis 432 through the hole and rigidly affixed to the first portion 444, the piezoelectric material 442 extending along a plane substantially perpendicular to the longitudinal axis 432.

In certain implementations, the second portion 446 of the oscillator 440 is configured to substantially move relative to the support portion 430 during the bending oscillations of the oscillator 440 (e.g., in response to time-varying electrical voltage signals applied across portions of the oscillator 440). For example, the second portion 446 can comprise at least a portion of a perimeter of the piezoelectric material 442 and can be in mechanical communication with the at least one mass 450 via at least one coupler 452 (e.g., clamp, screw, adhesive, epoxy), such that the bending oscillations move (e.g., vibrate) the second portion 446 and the at least one mass 450 along a direction substantially parallel to the longitudinal axis 432 of the support portion 430 (e.g., substantially perpendicular to the oscillator 440).

In certain implementations, the at least one mass 450 comprises one or more materials having sufficiently large mass density and dimensions (e.g., length; width; thickness; volume) such that the at least one mass 450 has a mass (e.g., weight) configured to achieve a predetermined resonant frequency for the bending oscillations (e.g., the generated vibrations) (e.g., in a range of 250 Hz to 3 kHz; about 750 Hz). Examples of such materials of the at least one mass 450 include but are not limited to: tungsten; tungsten alloy; osmium; osmium alloy. The at least one mass 450 can comprise a unitary (e.g., single; monolithic) component, multiple components (e.g., two or more sub-masses) that are affixed to one another, and/or multiple components that are separate from one another. In certain implementations, the at least one mass 450 comprises separate masses 450 positioned at separate locations at the second portion 446 of the oscillator 440. For example, the at least one mass 450 can comprise two or more separate masses 450 positioned at a perimeter of the piezoelectric material 442 (e.g., two masses 450 at opposite ends of a substantially rectangular piezoelectric material 442), such that the at least one mass 450 is spaced from the support portion 430. For another example, the at least one mass 450 can comprise a single mass 450 extending at least partially around a perimeter of the piezoelectric material 442. The at least one mass 450 of certain implementations extends from the second portion 446 of the oscillator 400 towards the support portion 430 (e.g., as shown schematically in FIGS. 2, 3A-3E, 4A-4C, 5A-5C, and 6).

Piezoelectric materials 442 of the oscillator 440 generally have very low intrinsic damping, resulting in sharp vibrational resonances (e.g., high Q value where the Q value is the resonance frequency divided by −3 dB bandwidth), poor sound quality, and/or mechanical failure. In certain implementations, the at least one damper 460 can be configured to damp at least one vibrational resonance of the at least one actuator 410 so as to improve the sound quality and/or to provide more durability to mechanical failure, as compared to the at least one actuator 410 without the at least one damper 460. In addition, the piezoelectric materials 442 are generally brittle, with material breaks occurring at microscopic bending levels and mechanical failure upon shocks or impacts to the at least one actuator 410. Furthermore, the piezoelectric materials 442 generally have rough surfaces such that the piezoelectric materials 442 do not make full contact when pressed against a hard, flat surface, resulting in uneven and/or unreliable force transfer and large local stresses. In certain implementations, the at least one damper 460 can be further configured to coat at least one surface of the piezoelectric element 442 (e.g., a surface in mechanical communication with the support portion 430 and/or the at least one mass 450) to provide a more even and/or more reliable force transfer, as compared to the at least one actuator 410 without the at least one damper 460.

In certain implementations, the at least one damper 460 comprises at least one damping material configured to deform in response to movement of the oscillator 400 and to dissipate at least some of the mechanical energy of the oscillator 400. For example, the at least one damping material can be resilient (e.g., elastically compressible; flexible) and/or viscoelastic. In certain implementations, the at least one damper 460 can provide viscoelastic damping (e.g., energy dissipation via internal friction within the at least one material) and/or structural damping (e.g., energy dissipation via friction between the at least one material and other portions of the at least one actuator 410). Examples of the at least one damping material of the at least one damper 460 compatible with certain implementations described herein include, but are not limited to: rubber, elastomer, Viton™ fluoroelastomer, or silicone (e.g., a gasket); viscoelastic element (e.g., layer); adhesive (e.g., double sided tape); foam (e.g., open cell or closed cell); and surface coatings and/or varnishes (e.g., having thicknesses less than 1 micron). Examples of elastomers compatible with certain implementations described herein include, but are not limited to, silicone rubber (VMQ), silicone gel, silicone foam, fluorosilicone rubber (FVMQ), Viton (FKM), Kalrez (FFKM), ethylene propylene diene rubber (EPDM), nitrile rubber (NBR), polyurethane rubber, and polyurethane foam. Examples of a viscous adhesive with a carrier (e.g., tape) compatible with certain implementations described herein include but are not limited to, viscoelastic damping polymer 110 and VHB™ adhesive transfer tapes 9460, 9469, 9473 available from 3M of St. Paul, Minnesota. The shapes, dimensions, and materials of the at least one damper 460 can be selected to tune a resonant vibrational frequency of the at least one actuator 410.

In certain implementations, the at least one damper 460 is positioned such that vibratory movement (e.g., vibration) of the oscillator 400 produces compressive forces and/or shearing forces on and/or within the at least one damper 460. In certain implementations, the at least one damper 460 comprises a relatively small thickness (e.g., less than 1 micron) and a relatively large surface area (e.g., on the order of tens of square millimeters) and is configured to damp the vibrations of the oscillator 400 via the shearing forces rather than the compressive forces.

FIG. 2 schematically illustrates a cross-sectional view of an example apparatus 400 having the at least one damper 460 positioned between the piezoelectric material 442 of the oscillator 440 and the at least one mass 450 in accordance with certain implementations described herein. For example, the at least one damper 460 can comprise at least one viscoelastic element (e.g., layer; gasket) between the oscillator 440 and the at least one mass 450. While FIG. 2 shows the at least one damper 460 comprising at least a portion of the at least one coupler 452, the at least one damper 460 can be separate from the at least one coupler 452. The at least one viscoelastic element can be adhered (e.g., affixed) to both the oscillator 440 and the at least one mass 450 (see, e.g., FIG. 2), or the at least one viscoelastic element can be clamped between the oscillator 440 and the at least one mass 450 (e.g., by a screw or retaining ring of the at least one mass 450.

In certain implementations, the at least one damper 460 comprises at least one layer that coats at least a portion of the piezoelectric material 442 (e.g., coated onto the piezoelectric material 442 by dipping the piezoelectric material 442 in polyurethane; nanocoating, parylene, or gold deposited onto the piezoelectric material 442) and substantially fills surface crevices of the piezoelectric material 442. The at least one layer can be compressed (e.g., squeezed) between the piezoelectric material 442 and another solid surface such that the at least one layer extends into (e.g., fills) surface crevices, voids, and/or cracks of the piezoelectric material 442 (e.g., smoothing the surface; provide a more even and/or more reliable force transfer). In certain implementations, the at least one damper 460 is adhered to the piezoelectric material 442 (e.g., by glue or epoxy), while in certain other implementations, the at least one damper 460 is held in place without being adhered to the piezoelectric material 442 (e.g., clamped without being glued or epoxied, thereby avoiding a fabrication step of applying a glue or epoxy and avoiding potential degradation of the glue or epoxy over time).

Vibratory movement of the oscillator 400 can produce compressive forces (e.g., in a direction substantially parallel to a direction of motion of the second portion 446) and/or shearing forces (e.g., in a direction substantially perpendicular to the direction of motion of the second portion 446) on and/or within the at least one damper 460. In certain implementations, the at least one coupler 452 is configured to allow relative movement between the second portion 446 and the at least one mass 450 in a direction substantially perpendicular to the direction of motion of the second portion 446 (e.g., allowing shearing forces on and/or within the at least one damper 460) while inhibiting relative movement between the second portion 446 and the at least one mass 450 in a direction substantially parallel to the direction of motion of the second portion 446 (e.g., inhibiting compressive forces on the at least one damper 460).

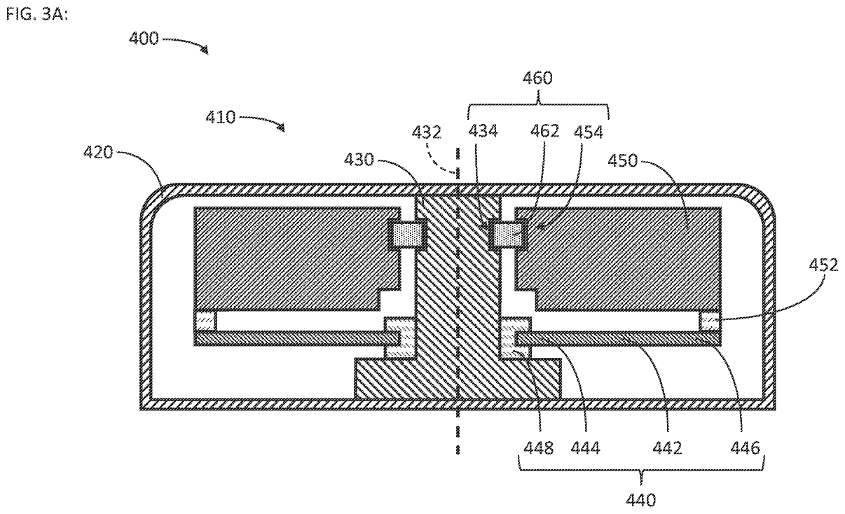

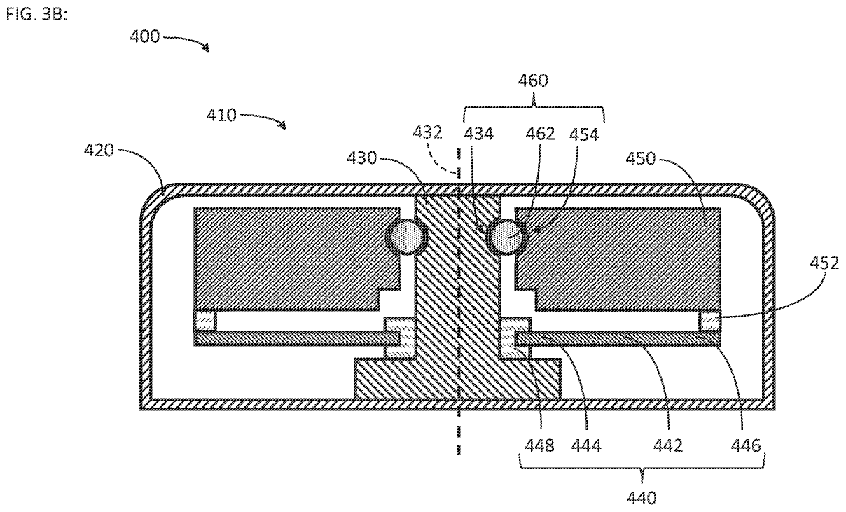

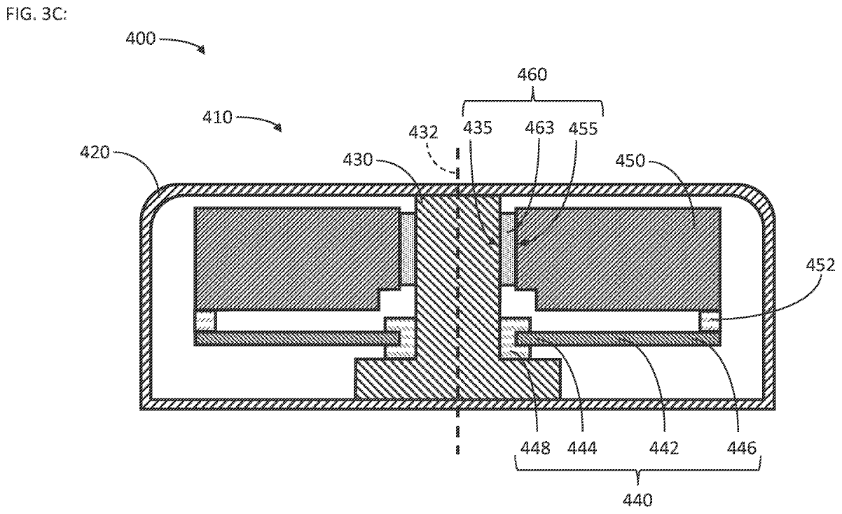

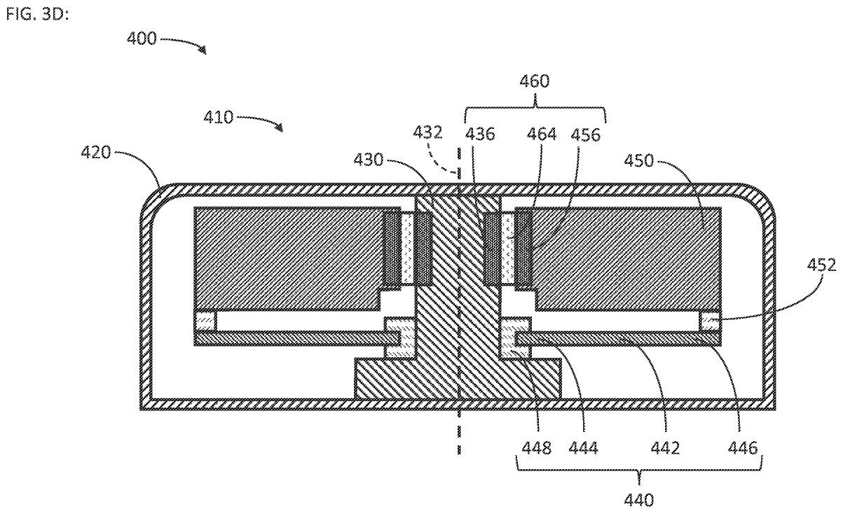

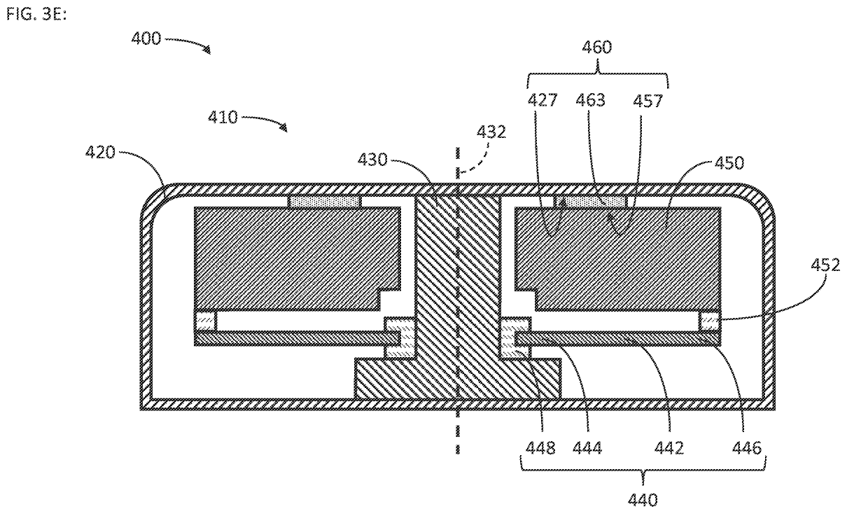

In certain implementations, the at least one damper 460 is mechanically affixed to both a substantially non-moving portion of the actuator 410 and a moving portion of the actuator 410. For example, FIGS. 3A-3D schematically illustrate cross-sectional views of an example apparatus 400 having the at least one damper 460 between the support portion 430 and the at least one mass 450 in accordance with certain implementations described herein. For another example, FIG. 3E schematically illustrates a cross sectional view of an example apparatus 400 having the at least one damper 460 between the housing 420 and the at least one mass 450 in accordance with certain implementations described herein. In certain implementations, the at least one damper 460 substantially surrounds the support portion 430, while in certain other implementations, the at least one damper 460 extends only partially around the support portion 430. In each of FIGS. 3A-3D, the at least one damper 460 is sufficiently soft (e.g., pliable) to shear forces to allow the at least one mass 450 to move relative to the support portion 430 in a direction substantially parallel to the longitudinal axis 432 in response to the bending oscillations of the oscillator 440 while providing a damping force that dissipates at least some of the mechanical energy of the at least one actuator 410. In FIG. 3E, the at least one damper 460 is sufficiently soft (e.g., pliable) to compressive forces to allow the at least one mass 450 to move relative to the support portion 430 in a direction substantially parallel to the longitudinal axis 432 in response to the bending oscillations of the oscillator 440 while providing a damping force that dissipates at least some of the mechanical energy of the at least one actuator 410.

As shown in FIGS. 3A and 3B, the at least one damper 460 comprises a gasket 462 (e.g., O-ring) comprising a viscoelastic material (e.g., rubber; elastomer; Viton™ fluoroelastomer; silicone). While FIGS. 3A and 3B show the gasket 462 held within a first channel 434 (e.g., slot; recess) of the support portion 430 and a second channel 454 (e.g., slot; recess) of the at least one mass 450, in certain other implementations, the gasket 462 is held within only a single channel (e.g., single slot or recess of the support portion 430 or of the at least one mass 450). In certain implementations, the gasket 462 has a substantially rectangular cross-section (see, e.g., FIG. 3A), a substantially circular cross-section (see, e.g., FIG. 3B), or another cross-sectional shape (e.g., oval; polygonal; geometric; non-geometric; regular; irregular).

In certain implementations, the at least one damper 460 comprises a viscoelastic layer 463 (e.g., silicone and/or foam cured in place; double-sided tape) between and affixed to a surface 435 of the support portion 430 and a surface 455 of the at least one mass 450 (see, e.g., FIG. 3C) or between and affixed to a surface 427 of the housing 420 and a surface 457 of the at least one mass 450 (see, e.g., FIG. 3E). In certain other implementations, the at least one damper 460 comprises a viscoelastic element (e.g., layer) between and affixed to a surface of the housing 420 and the second portion 446 of the oscillator 440.

FIG. 3D schematically illustrates a cross-sectional view of an example apparatus 400 in which the at least one damper 460 comprises at least one first permanent magnet 436 in mechanical communication with the support portion 430, at least one second permanent magnet 456 in mechanical communication with the at least one mass 450, and at least one viscoelastic material comprising a ferrofluid 464 between the at least one first permanent magnet 436 and the at least one second permanent magnet 456. The ferrofluid 464 comprises a plurality of ferromagnetic or ferrimagnetic particles loosely bound together such that the particles can move relative to one another thereby generating friction which damps the mechanical energy of the at least one actuator 410. In certain other implementations, the at least one damper 460 comprises other types of a plurality of elements (e.g., a bundle of resilient fibers, such as a rope of wires, or a plurality of granules) configured to move relative to one another in response to movement of the oscillator 400, the moving elements loosely bound together and dissipating at least some of the mechanical energy via friction between the elements.

In certain other implementations, the at least one damper 460 can comprise a viscoelastic material (e.g., soft polyurethane; silicone; foam) that surrounds and contacts substantially the whole assembly within the housing 420 (e.g., the support portion 430, the oscillator 440, and the at least one mass 450). For example, the viscoelastic material can be injected into substantially the whole interior volume of the housing 420.

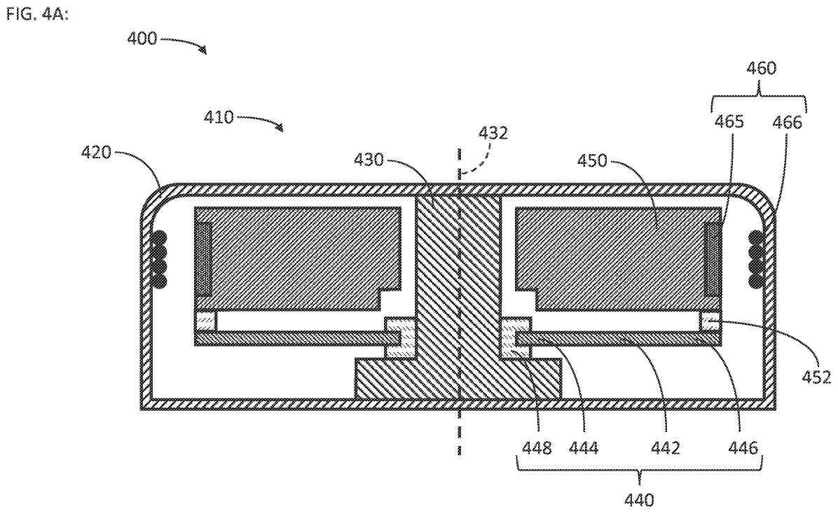

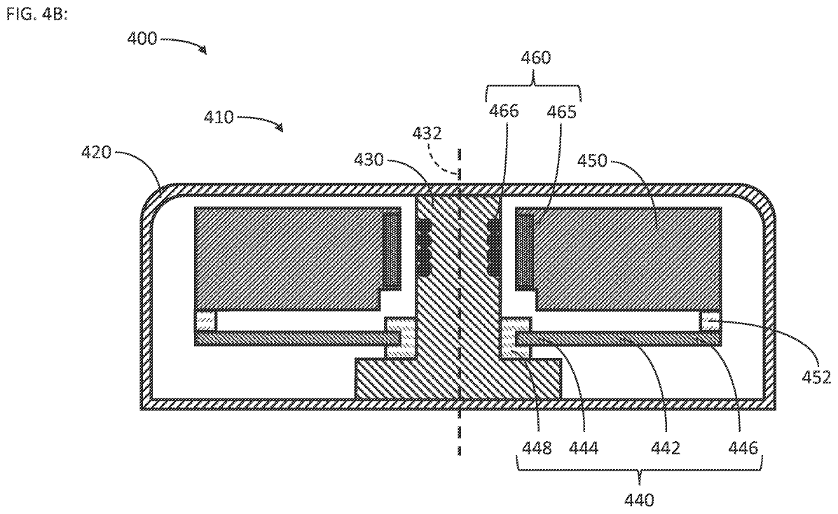

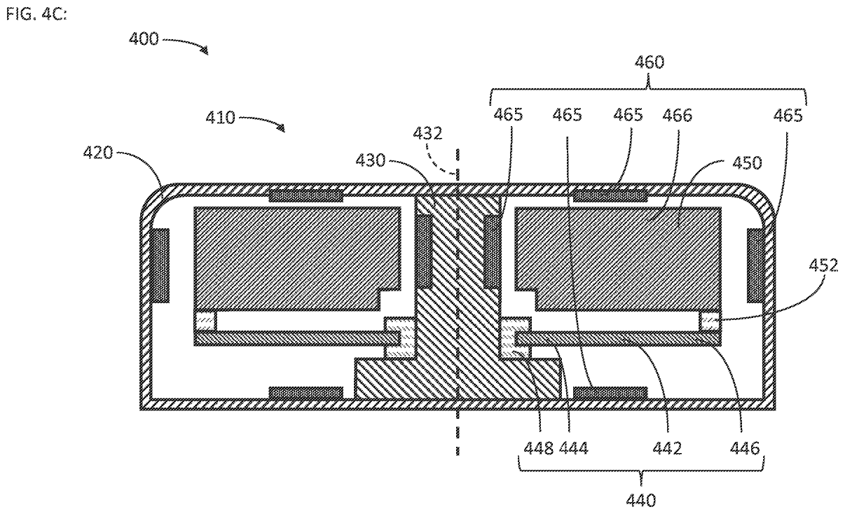

FIGS. 4A-4C schematically illustrate cross-sectional views of an example apparatus 400 in which the at least one damper 460 comprises at least one permanent magnet 465 configured to generate eddy currents within an electrically conductive portion 466 of the at least one actuator 410 in response to the bending oscillations of the oscillator 440 in accordance with certain implementations described herein. The eddy currents can be configured to dissipate energy in the electrically conductive portion 466. In certain implementations, the at least one permanent magnet 465 is affixed to a moving portion of the actuator 410 and the electrically conductive portion 466 comprises a portion of or is affixed to a substantially non-moving portion of the actuator 410 (see, e.g., FIGS. 4A and 4B). In certain other implementations, the at least one permanent magnet 465 is affixed to a substantially non-moving portion of the actuator 410 and the electrically conductive portion 466 is a portion of or is affixed to a moving portion of the actuator 410 (see, e.g., FIG. 4C).

As schematically illustrated by FIG. 4A, the at least one permanent magnet 465 is affixed to the at least one mass 450 and the electrically conductive portion 466 comprises a shorted wire coil attached to the housing 420. As schematically illustrated by FIG. 4B, the at least one permanent magnet 465 is affixed to the at least one mass 450 and the electrically conductive portion 466 comprises a shorted wire coil (e.g., gold; copper) attached to the support portion 430. The at least one permanent magnet 465 and the wire coil of the electrically conductive portion 466 can be configured to be tuned to provide a predetermined eddy current damping of the oscillations of the at least one actuator 410. For example, the wire coil can comprise at least one capacitor or other circuitry selected to constrain the eddy currents generated within the wire coil.

In certain other implementations, the electrically conductive portion 466 comprises a portion of the housing 420 and/or the support portion 430 and/or the at least one mass 450. For example, as schematically illustrated by FIG. 4C, the at least one mass 450 (e.g., comprising tungsten with an electrical resistivity of 5.6×10⁻⁸ Ohm-m) comprises the electrically conductive portion 466 and the at least one permanent magnet 465 comprises a plurality of permanent magnets 465 affixed to the housing 420 and/or the support portion 430. In certain implementations, the housing 420 and/or the support portion 430 and/or the at least one mass 450 comprises a material with a high electrical resistivity (e.g., grade 5 titanium with an electrical resistivity of 1.7×10⁻⁶ Ohm-m), and the electrically conductive portion 466 comprises an electrically conductive layer (e.g., gold having an electrical resistivity of 2.8×10⁻⁸ Ohm-m) on a surface of the housing 420 and/or the support portion 430 and/or the at least one mass 450.

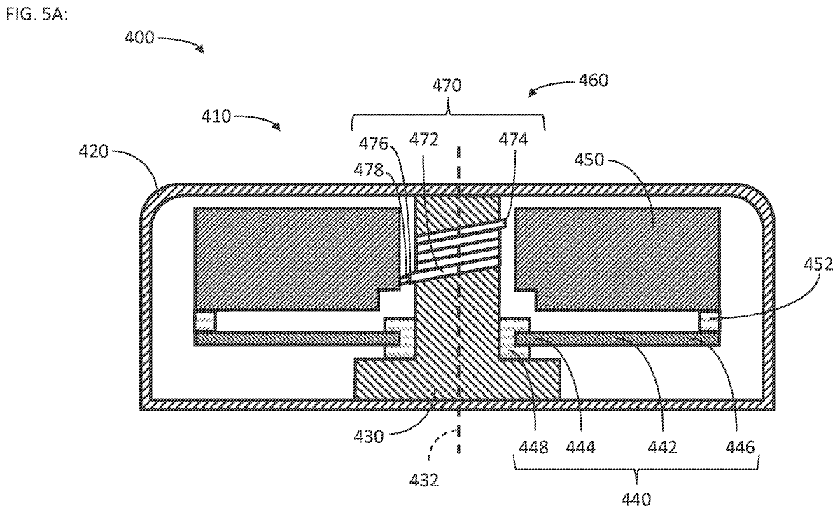

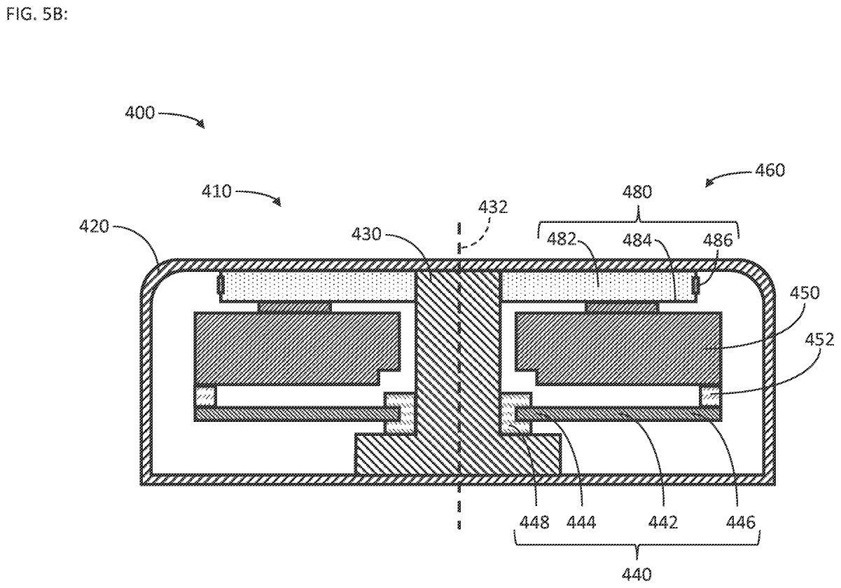

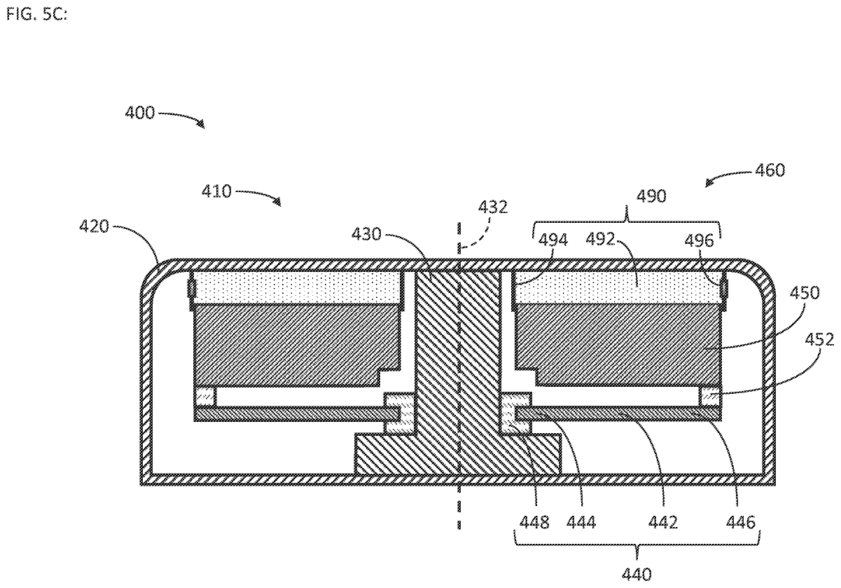

FIGS. 5A-5C schematically illustrate cross-sectional views of three example apparatus 400 utilizing a viscous material in accordance with certain implementations described herein. FIG. 5A schematically illustrates a cross-sectional view of an example apparatus 400 in which the at least one damper 460 comprises a coiled piston damper 470 affixed to a substantially non-moving portion of the actuator 410 (e.g., support portion 430) and in mechanical communication with a moving portion of the actuator 410 (e.g., at least one mass 450). In certain other implementations, the coiled piston damper 470 is affixed to a moving portion of the actuator 410 and is in mechanical communication with a substantially non-moving portion of the actuator 410. As schematically illustrated by FIG. 5A, the coiled piston damper 470 can comprise a coiled tube 472 containing a viscous material (e.g., gas; liquid; gel) and having a first end 474, a second end 476 spaced from the first end 474, and a movable piston 478 at the second end 476 in mechanical communication with the at least one mass 450. The piston 478 can be configured to move relative to the tube 472 in response to movement of the at least one mass 450 to apply a force on the viscous material within the tube 472.

For example, the first end 474 can be open to the environment within the housing 420 and the viscous material within the tube 472 can be the same gas (e.g., helium) that fills the environment within the housing 420 surrounding the oscillator 440 and the at least one mass 450. The first end 474 can comprise a mesh (e.g., acoustic resistance mesh, examples of which are available from Knowles Electronics of Itasca, Illinois) and/or an open cell foam (e.g., Panasorb® foam, available from Flexolan Foam GmbH of Diedorf, Bayern, Germany; Basotect® foam, available from BASF of Ludwigshafen, Germany). For another example, the first end 474 can be closed to the environment within the housing 420 and the viscous material within the tube 472 can comprise a material (e.g., fluid; gel) different from the gas that fills the environment within the housing 420 surrounding the oscillator 440 and the at least one mass 450. By moving the piston 478 and applying a force on the viscous material within the tube 476 in response to vibrations of the oscillator 440, the coiled piston damper 470 can be configured to damp vibrational resonances of the at least one actuator 410.

FIG. 5B schematically illustrates a cross-sectional view of an example apparatus 400 in which the at least one damper 460 comprises a membrane damper 480 affixed to a substantially non-moving portion of the actuator 410 (e.g., housing 420 and/or support portion 430) and in mechanical communication with a moving portion of the actuator 410 (e.g., at least one mass 450). As schematically illustrated by FIG. 5B, the membrane damper 480 can comprise a reservoir 482 containing a fluid (e.g., gas; helium; nitrogen; air), a movable membrane 484 (e.g., rubber; compliant thin metal) at least partially bounding the volume within the reservoir 482 and in mechanical communication with the at least one mass 450, and at least one orifice 486 configured to allow the gas to flow out of and into the reservoir 482 (e.g., to and from the environment within the housing 420 surrounding the oscillator 440 and the at least one mass 450). In response to movement of the at least one mass 450, the membrane 484 moves thereby changing the volume of the reservoir 482 and forcing the gas to flow through the at least one orifice 486. By moving the membrane 484 and applying a force on the gas within the reservoir 482 in response to vibrations of the oscillator 440, the membrane damper 480 can be configured to damp vibrational resonances of the at least one actuator 410.

FIG. 5C schematically illustrates a cross-sectional view of an example apparatus 400 in which the at least one damper 460 comprises a membrane-less damper 490 affixed to a substantially non-moving portion of the actuator 410 (e.g., housing 420 and/or support portion 430) and in mechanical communication with a moving portion of the actuator 410 (e.g., at least one mass 450). As schematically illustrated by FIG. 5C, the membrane-less damper 490 can comprise a reservoir 492 containing a gas (e.g., helium; nitrogen; air), one or more walls 494 at least partially bounding the volume of the reservoir 492, and at least one orifice 496 configured to allow the gas to flow out of and into the reservoir 492 (e.g., to and from the environment within the housing 420 surrounding the oscillator 440 and the at least one mass 450). At least one surface of the at least one mass 450 at least partially bounds the volume within the reservoir 492. In certain implementations, the membrane-less damper 490 comprises a seal (e.g., O-ring) between the at least one mass 450 and the one or more walls 494. In response to movement of the at least one mass 450, the volume of the reservoir 492 changes thereby forcing the gas to flow through the at least one orifice 496. By applying a force on the gas within the reservoir 492 in response to vibrations of the oscillator 440, the membrane-less damper 490 can be configured to damp vibrational resonances of the at least one actuator 410.

In certain other implementations, one or more of the moving portions of the actuator 410 (e.g., oscillator 440; at least one mass 450) comprises at least one perforation extending from a first surface to a second surface (e.g., the first and second surfaces substantially parallel to one another and substantially perpendicular to the direction of motion of the at least one mass 450). The at least one perforation can be configured to allow a gas (e.g., helium; nitrogen; air) in the environment within the housing 420 and surrounding the oscillator 440 and the at least one mass 450 to flow through the at least one perforation in response to movement of the moving portion during vibration of the at least one actuator 410. The at least one perforation can be configured to damp vibrational resonances of the at least one actuator 410.

In certain implementations, the at least one orifice of the at least one actuator 410 (e.g., at least one orifice 486 of the membrane damper 480; at least one orifice 496 of the membrane-less damper 490; at least one perforation of the moving portion) comprises a mesh (e.g., acoustic resistance mesh, examples of which are available from Knowles Electronics of Itasca, Illinois) and/or an open cell foam (e.g., Panasorb® foam, available from Flexolan Foam GmbH of Diedorf, Bayern, Germany; Basotect® foam, available from BASF of Ludwigshafen, Germany). The mesh and/or open cell foam is configured to increase the flow resistance of the gas into and out of the reservoir 482, 492 or through the at least one perforation.

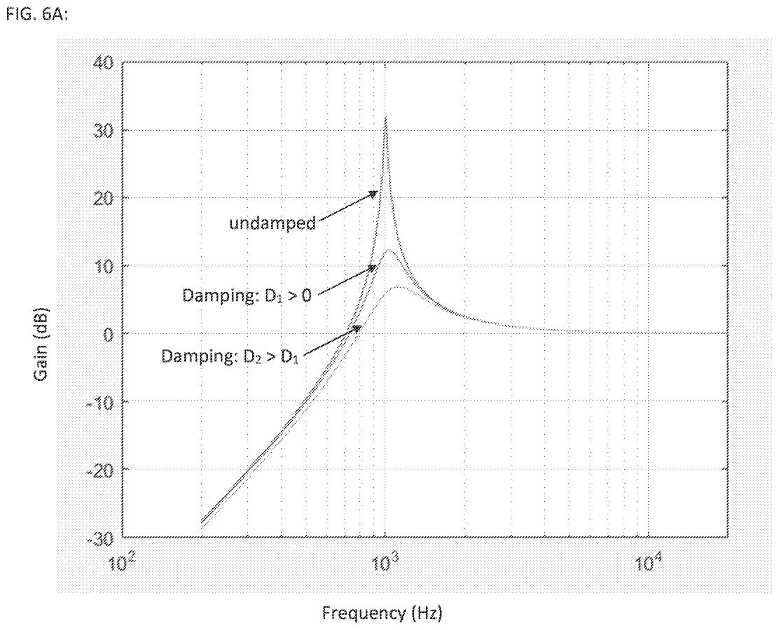

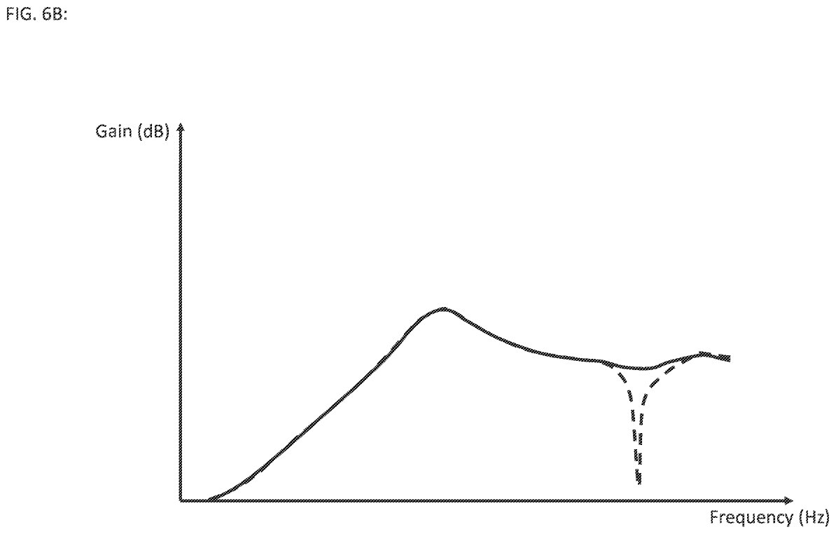

FIG. 6A schematically illustrates an example damping of a vibrational resonance in accordance with certain implementations described herein. The vibrational resonance spectrum of an undamped actuator is shown by one line in FIG. 6A, and the vibrational resonance spectrum of an actuator with various non-zero amounts of damping are shown with two other lines in FIG. 6A. For increasing amounts of damping, a vibrational resonance (e.g., at about 1 kHz) of the undamped actuator is reduced in magnitude and is shifted towards higher frequencies. FIG. 6B schematically illustrates an example damping of a vibrational antiresonance in accordance with certain implementations described herein. The vibrational resonance spectrum of an undamped actuator is shown with a dashed line in FIG. 6B, and the vibrational resonance spectrum of an actuator with damping is shown with a solid line in FIG. 6B. For the damping actuator, the notch of a vibrational antiresonance of the undamped actuator is more shallow and the response is smoothened.

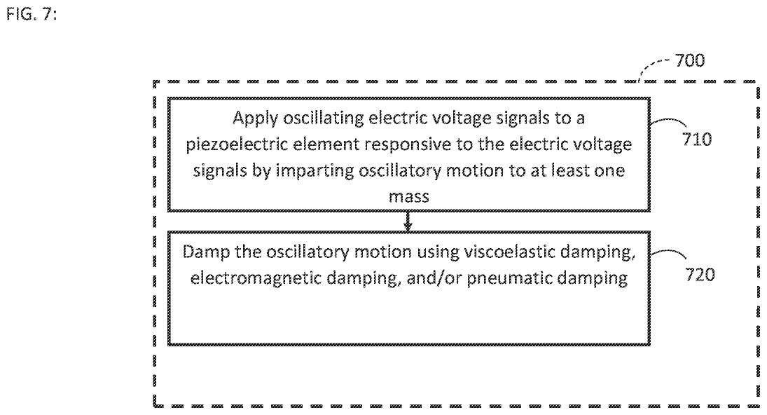

FIG. 7 is a flow diagram of an example method 700 in accordance with certain implementations described herein. In an operational block 710, the method 700 comprises applying oscillating electric voltage signals to a piezoelectric element (e.g., oscillator 440) mechanically coupled to a rigid portion (e.g., support portion 430) and to at least one mass (e.g., at least one mass 450). The piezoelectric element responds to the electric voltage signals by imparting oscillatory motion to the at least one mass relative to the rigid portion. For example, the rigid portion can be rigidly affixed to a fixture implanted within the recipient's body, and the rigid portion and the fixture can be configured to transmit vibrational energy from the piezoelectric element to the recipient's body.

In an operational block 720, the method 700 further comprises damping the oscillatory motion using viscoelastic damping, electromagnetic damping, and/or pneumatic damping. For example, the damping comprises lessening a magnitude of at least one vibrational resonance of the piezoelectric element independently from spring damping of the piezoelectric element. In certain implementations, said damping using viscoelastic damping comprises applying a shearing force to a viscoelastic material. For example, the viscoelastic material can be between a surface of the at least one mass and a substantially non-oscillating surface or between a surface of the at least one mass and a surface of the piezoelectric element. In certain such implementations, the viscoelastic material comprises a coating on the surface of the piezoelectric element.

Although commonly used terms are used to describe the systems and methods of certain implementations for ease of understanding, these terms are used herein to have their broadest reasonable interpretations. Although various aspects of the disclosure are described with regard to illustrative examples and implementations, the disclosed examples and implementations should not be construed as limiting. Conditional language, such as, among others, “can,” “could,” “might,” or “may,” unless specifically stated otherwise, or otherwise understood within the context as used, is generally intended to convey that certain implementations include, while other implementations do not include, certain features, elements and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

It is to be appreciated that the implementations disclosed herein are not mutually exclusive and may be combined with one another in various arrangements. In addition, although the disclosed methods and apparatuses have largely been described in the context of conventional cochlear implants, various implementations described herein can be incorporated in a variety of other suitable devices, methods, and contexts. More generally, as can be appreciated, certain implementations described herein can be used in a variety of implantable medical device contexts that can benefit from having at least a portion of the received power available for use by the implanted device during time periods in which the at least one power storage device of the implanted device unable to provide electrical power for operation of the implantable medical device.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within ±10% of, within ±5% of, within ±2% of, within ±1% of, or within ±0.1% of the stated amount. As another example, the terms “generally parallel” and “substantially parallel” refer to a value, amount, or characteristic that departs from exactly parallel by ±10 degrees, by ±5 degrees, by ±2 degrees, by ±1 degree, or by ±0.1 degree, and the terms “generally perpendicular” and “substantially perpendicular” refer to a value, amount, or characteristic that departs from exactly perpendicular by ±10 degrees, by ±5 degrees, by ±2 degrees, by ±1 degree, or by ±0.1 degree. The ranges disclosed herein also encompass any and all overlap, sub-ranges, and combinations thereof. Language such as “up to,” “at least,” “greater than,” less than,” “between,” and the like includes the number recited. As used herein, the meaning of “a,” “an,” and “said” includes plural reference unless the context clearly dictates otherwise. Also, as used in the description herein, the meaning of “in” includes “into” and “on,” unless the context clearly dictates otherwise.

While the methods and systems are discussed herein in terms of elements labeled by ordinal adjectives (e.g., first, second, etc.), the ordinal adjective are used merely as labels to distinguish one element from another (e.g., one signal from another or one circuit from one another), and the ordinal adjective is not used to denote an order of these elements or of their use.

The invention described and claimed herein is not to be limited in scope by the specific example implementations herein disclosed, since these implementations are intended as illustrations, and not limitations, of several aspects of the invention. Any equivalent implementations are intended to be within the scope of this invention. Indeed, various modifications of the invention in form and detail, in addition to those shown and described herein, will become apparent to those skilled in the art from the foregoing description. Such modifications are also intended to fall within the scope of the claims. The breadth and scope of the invention should not be limited by any of the example implementations disclosed herein, but should be defined only in accordance with the claims and their equivalents.

1. An apparatus comprising:
at least one actuator configured to generate vibrations over a range of vibration frequencies, the at least one actuator comprising:
a housing configured to be positioned on or within a recipient's body;
a support portion configured to be in operative communication with a fixture implanted within the recipient's body;
an oscillator within the housing, the oscillator comprising piezoelectric material and having a first portion in mechanical communication with the support portion and a second portion spaced from the support portion, the piezoelectric material configured to undergo bending oscillations in response to received electric voltage signals in which the second portion moves relative to the first portion;
at least one mass within the housing and in mechanical communication with the second portion, the at least one mass configured to move with the second portion in response to the bending oscillations of the piezoelectric material; and
at least one damper configured to damp at least one vibrational resonance of the at least one actuator over at least a portion of the range of vibration frequencies and independently of spring damping by the piezoelectric material.

2. The apparatus of claim 1, wherein the at least one damper comprises at least one viscoelastic element between the oscillator and the at least one mass, between the oscillator and the housing, between the at least one mass and the support portion, and/or between the at least one mass and the housing.

3. The apparatus of claim 2, wherein the at least one viscoelastic element comprises a viscoelastic layer between the piezoelectric material and the at least one mass, between the support portion and the at least one mass, and/or between the at least one mass and the housing.

4. The apparatus of claim 2, wherein the at least one viscoelastic element comprises an O-ring or gasket between the support portion and the at least one mass.

5. The apparatus of claim 2, further comprising at least one first permanent magnet in mechanical communication with the support portion and at least one second permanent magnet in mechanical communication with the at least one mass, and the at least one viscoelastic material comprising a ferrofluid between the at least one first permanent magnet and the at least one second permanent magnet.

6. The apparatus of claim 1, wherein the at least one damper comprises at least one permanent magnet configured to generate eddy currents within an electrically conductive portion of the at least one actuator in response to the bending oscillations of the oscillator.

7. The apparatus of claim 6, wherein the at least one permanent magnet is affixed to the at least one mass and the electrically conductive portion comprises a portion of the housing and/or the support portion.

8. The apparatus of claim 6, wherein the at least one permanent magnet is in mechanical communication with the at least one mass and the electrically conductive portion comprises a wire coil attached to the housing and/or the support portion.

9. The apparatus of claim 6, wherein the at least one permanent magnet is in mechanical communication with the housing and/or the support portion and the electrically conductive portion comprises a portion of the at least one mass.

10. The apparatus of claim 1, wherein the at least one damper comprises a reservoir containing a fluid and a movable portion in mechanical communication with the reservoir and the at least one mass, the movable portion configured to move and change a volume within the reservoir in response to movement of the at least one mass.

11. The apparatus of claim 10, wherein the movable portion comprises a membrane at least partially bounding the volume within the reservoir.

12. The apparatus of claim 10, wherein the movable portion comprises at least one surface of the at least one mass, the at least one surface at least partially bounding the volume within the reservoir.

13. The apparatus of claim 10, wherein the at least one damper comprises at least one orifice configured to allow gas to flow therethrough into and out of the volume within the reservoir.

14. The apparatus of claim 13, wherein the at least one orifice comprises a plurality of orifices through an open cell foam material and/or a mesh.

15. The apparatus of claim 1, wherein the at least one damper comprises at least one perforation extending from a first surface of the at least one mass to a second surface of the at least one mass, the at least one perforation configured to allow gas to flow therethrough in response to movement of the at least one mass.

16. The apparatus of claim 15, wherein the first surface and the second surface are substantially parallel to one another and substantially perpendicular to a direction of motion of the at least one mass.

17. The apparatus of claim 15, wherein the at least one perforation comprises a plurality of perforations through an open cell foam material and/or a mesh.

18. A method comprising:
applying oscillating electric voltage signals to a piezoelectric element mechanically coupled to a rigid portion and to at least one mass, the piezoelectric element responding to the electric voltage signals by imparting oscillatory motion to the at least one mass relative to the rigid portion; and
damping the oscillatory motion using viscoelastic damping, electromagnetic damping, and/or pneumatic damping.

19. The method of claim 18, wherein the rigid portion is rigidly affixed to a fixture implanted within a recipient's body, the rigid portion and the fixture configured to transmit vibrational energy from the piezoelectric element to the recipient's body.

20. The method of claim 18, wherein said damping comprises lessening a magnitude of at least one vibrational resonance of the piezoelectric element independently from spring damping of the piezoelectric element.

21. The method of claim 18, wherein said damping comprises applying a shearing force to a viscoelastic material.

22. The method of claim 21, wherein the viscoelastic material is between a surface of the at least one mass and a substantially non-oscillating surface or between a surface of the at least one mass and a surface of the piezoelectric element.

23. The method of claim 21, wherein the viscoelastic material comprises a coating on the surface of the piezoelectric element.

24. An apparatus comprising:
a piezoelectric actuator configured to generate vibrational signals in response to oscillating electric voltage signals, the piezoelectric actuator configured to be implanted on or within a recipient's body and to transmit the vibrational signals to the recipient's body, the piezoelectric actuator comprising at least one damper configured to use non-spring damping to damp at least one vibrational resonance of the piezoelectric actuator.

25.-28. (canceled)

29. An apparatus comprising:
an actuator configured to be implanted on or within a recipient's body and to transmit the vibrational signals to the recipient's body, the actuator comprising at least one piezoelectric material and at least one surface layer overlaying a surface of the at least one piezoelectric material, the at least one piezoelectric material configured to generate vibrational signals in response to oscillating electric voltage signals, the at least one surface layer extending into surface crevices, voids, and/or cracks of the at least one piezoelectric material.

30.-32. (canceled)
